(19) United States
(12) Patent Application Publication
(10) Pub. No.: US 2013/0156163 A1
(43) Pub. Date: Jun. 20, 2013

(54) METHOD AND APPARATUS FOR RECONSTRUCTING AN IMAGE OF AN OBJECT

(71) Applicants: Xin Liu, Waukesha, WI (US); Jiang Hsieh, Brookfield, WI (US)

(72) Inventors: Xin Liu, Waukesha, WI (US); Jiang Hsieh, Brookfield, WI (US)

(73) Assignee: GENERAL ELECTRIC COMPANY, Schenectady, NY (US)

(21) Appl. No.: 13/330,128

(22) Filed: Dec. 19, 2011

(51) Int. Cl. G01D 18/00

(52) U.S. Cl. 378/207

(57) ABSTRACT

A method for reconstructing an image of an object includes performing an air calibration on an imaging system to generate set of air calibration data, estimating an x-ray spectrum using the air calibration data, and reconstructing an image of an object using the estimated x-ray spectrum. An imaging system and a non-transitory computer readable medium are also described herein.

### BACKGROUND OF THE INVENTION

This subject matter disclosed herein relates generally to imaging systems, and more particularly, to a method and apparatus for reconstructing an image of an object.

Non-invasive imaging broadly encompasses techniques for generating images of the internal structures or regions of a person or object. One such imaging technique is known as x-ray computed tomography (CT). CT imaging systems measure the attenuation of x-ray beams that pass through the object from numerous angles (often referred to as projection data). Based upon these measurements, a computer is able to process and reconstruct images of the portions of the object responsible for the radiation attenuation.

The performance of CT systems is highly dependent on the quality of a calibration process. In general, the calibration process enables the reduction or elimination of suboptimal projection measurements caused by the fundamental properties of physics, e.g., beam hardening, limitation of the component performance, such as detector gain variation, and/or the non-ideal installation process, such as system alignment. One such calibration process includes a spectral calibration which may be rather time consuming. The spectral calibration is performed on the detector elements to determine spectral response differences among the detector elements. Inaccurate determination of spectral response differences between detector elements due to, for example, beam hardening through water, soft-tissue, bone and contrast agents, and detector imperfection, may result in imaging artifacts.

Moreover, the x-ray spectral response of the CT system may change over time. More specifically, while the initial calibration process is generally effective to calibrate the CT system at an initial point in time, subsequent use of the CT imaging system may render the initial calibration less than optimal or ineffective. Thus, imaging artifacts may once again occur in reconstructed images. Therefore, the conventional spectral calibration may need to be repeated at various intervals. As a result, each spectral calibration increases the time the CT system in not operational to perform diagnostic imaging.

### BRIEF DESCRIPTION OF THE INVENTION

In one embodiment, a method for reconstructing an image of an object is provided. The method includes performing an air calibration on an imaging system to generate set of air calibration data, estimating an x-ray spectrum using the air calibration data, and reconstructing an image of an object using the estimated x-ray spectrum.

In another embodiment, an imaging system is provided. The imaging system includes an imaging scanner and a processor coupled to the imaging scanner. The processor is configured to perform an air calibration on an imaging system to generate set of air calibration data, estimate an x-ray spectrum using the air calibration data, and reconstruct an image of an object using the estimated x-ray spectrum.

In a further embodiment, a non-transitory computer readable medium is provided. The non-transitory computer readable medium is programmed to instruct a computer to perform an air calibration on an imaging system to generate set of air calibration data, estimate an x-ray spectrum using the air calibration data, and reconstruct an image of an object using the estimated x-ray spectrum.

### BRIEF DESCRIPTION OF THE DRAWINGS

FIG. 1 is a simplified block diagram of an exemplary imaging system formed in accordance with various embodiments.

FIG. 2 is a flowchart of a method for reconstructing an image of an object in accordance with various embodiments.

FIG. 3 is an exemplary image that may be formed in accordance with various embodiments.

FIG. 4 is another exemplary image that may be formed in accordance with various embodiments.

FIG. 5 is an exemplary graph that may be formed in accordance with various embodiments.

FIG. 6 is another exemplary graph that may be formed in accordance with various embodiments.

FIG. 7 is an exemplary image used to explain various embodiments described herein.

FIG. 8 is a pictorial view of a multi-modality imaging system formed in accordance with various embodiments.

FIG. 9 is a block schematic diagram of the system illustrated in FIG. 8.

### DETAILED DESCRIPTION OF THE INVENTION

The foregoing summary, as well as the following detailed description of various embodiments, will be better understood when read in conjunction with the appended drawings. To the extent that the figures illustrate diagrams of the functional blocks of the various embodiments, the functional blocks are not necessarily indicative of the division between hardware circuitry. Thus, for example, one or more of the functional blocks (e.g., processors or memories) may be implemented in a single piece of hardware (e.g., a general purpose signal processor or a block of random access memory, hard disk, or the like) or multiple pieces of hardware. Similarly, the programs may be stand alone programs, may be incorporated as subroutines in an operating system, may be functions in an installed software package, and the like. It should be understood that the various embodiments are not limited to the arrangements and instrumentality shown in the drawings.

In various embodiments, a method and/or apparatus is provided that estimates an x-ray spectrum of an x-ray source. A technical effect of various embodiments is to enable air scan information, acquired during a daily air scan calibration, to be utilized in conjunction with a priori knowledge of a bowtie filter, to estimate the x-ray spectrum of the x-ray source in real-time.

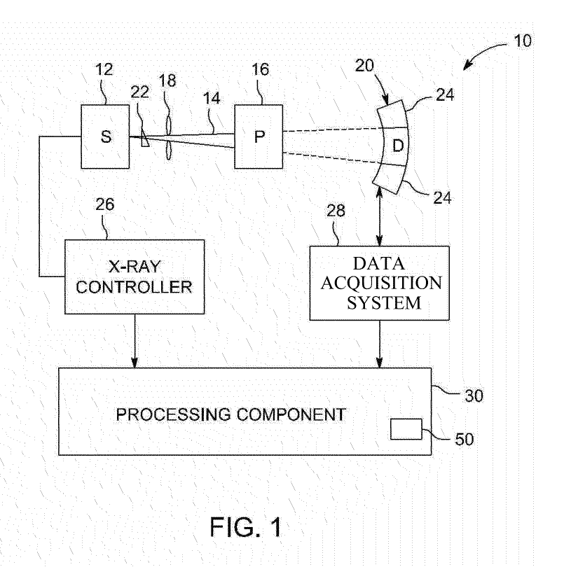

FIG. 1 is a simplified block diagram of a computed tomography (CT) imaging system 10 that is formed in accordance with various embodiments. The imaging system 10 may be utilized to acquire x-ray attenuation data at a variety of views around a volume undergoing imaging (e.g., a patient, package, manufactured part, and so forth). The imaging system 10 includes an x-ray source 12 that is configured to emit radiation, e.g., x-rays 14, through a volume containing a subject 16, e.g. a patient being imaged.

In the embodiment shown in FIG. 1, the imaging system 10 also includes an adjustable collimator 18. In operation, the emitted x-rays 14 pass through an opening of the adjustable collimator 18 which limits the angular range associated with the x-rays 14 passing through the volume in one or more dimensions. More specifically, the collimator 18 shapes the emitted x-rays 14, such as to a generally cone or generally fan shaped beam that passes into and through the imaging volume in which the subject or object of the imaging process, e.g., the subject 16, is positioned. The collimator 18 may be adjusted to accommodate different scan modes, such as to provide a narrow fan-shaped x-ray beam in a helical scan mode and a wider cone-shaped x-ray beam in an axial scan mode. The collimator 18 may be formed, in one embodiment, from two cylindrical disks that rotate to adjust the shape or angular range of the x-rays 14 that pass through the imaging volume. Optionally, the collimator 18 may be formed using two or more translating plates or shutters. In various embodiments, the collimator 18 may be formed such that an aperture defined by the collimator 18 corresponds to a shape of a radiation detector 20.

The imaging system 10 also includes a filter 22 that is disposed between the x-ray source 12 and the collimator 18. In various embodiments, the filter 22 is a bowtie filter having a predetermined thickness and fabricated from a predetermined material. In operation, the x-rays 14 pass through the filter 22 which adjusts a frequency and/or an intensity characteristic of the emitted x-rays 14. The bowtie filter 22 may be a conventional bowtie filter or other X-ray beam shaping filter suitable for varying the intensity of the beam of x-rays 14 to compensate for different thicknesses of the subject 16 as seen from different angular positions of the x-ray source 12. In one embodiment, the thickness of the bowtie filter 22 may vary in the axial direction to compensate for the Heel effect. Optionally, a separate or additional filter having a thickness that varies in the axial direction may be provided in conjunction with the bowtie filter 22 to compensate for the Heel effect.

In operation, the x-rays 14 pass through or around the subject 16 and impinge the detector 20. The detector 20 includes a plurality of detector elements 24 that may be arranged in a single row or a plurality of rows to form an array of detector elements 24. The detector elements 24 generate electrical signals that represent the intensity of the incident x-rays 14. The electrical signals are acquired and processed to reconstruct images of one or more features or structures within the subject 16. In various embodiments, the imaging system 10 may also include an anti-scatter grid (not shown) to absorb or otherwise prevent x-ray photons that have been deflected or scattered in the imaging volume from impinging the detector 20. The anti-scatter grid may be a one-dimensional or two-dimensional grid and/or may include multiple sections, some of which are one-dimensional and some of which are two-dimensional.

The imaging system 10 also includes an x-ray controller 26 that is configured to provide power and timing signals to the x-ray source 12. The imaging system 10 further includes a data acquisition system 28. In operation, the data acquisition system 28 receives data collected by readout electronics of the detector 20. The data acquisition system 28 may receive sampled analog signals from the detector 20 and convert the data to digital signals for subsequent processing by a processor 30. Optionally, the digital-to-analog conversion may be performed by circuitry provided on the detector 20.

The processor 30 is programmed to perform functions described herein, and as used herein, the term processor is not limited to just integrated circuits referred to in the art as computers, but broadly refers to computers, microcontrollers, microcomputers, programmable logic controllers, application specific integrated circuits, and other programmable circuits, and these terms are used interchangeably herein.

The imaging system 10 also includes a spectrum estimation module 50 that is configured to implement various spectrum estimation methods described herein. For example, the spectrum estimation module 50 may be configured to automatically perform a spectrum estimation of the imaging system 10. The spectrum estimation module 50 may be implemented as a piece of hardware that is installed in the processor 30. Optionally, the spectrum estimation module 50 may be implemented as a set of instructions that are installed on the processor 30. The set of instructions may be stand alone programs, may be incorporated as subroutines in an operating system installed on the processor 30, may be functions in an installed software package on the processor 30, or may be a combination of software and hardware. It should be understood that the various embodiments are not limited to the arrangements and instrumentality shown in the drawings.

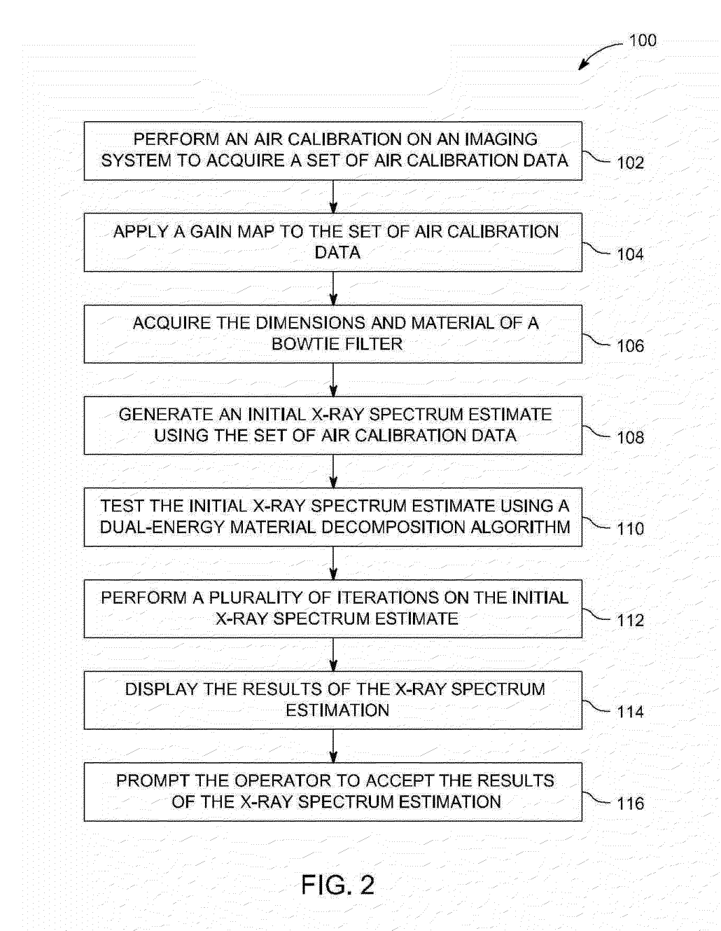

FIG. 2 is a flowchart of a method 100 for reconstructing an image of an object in accordance with various embodiments. The method 100 may be implemented as a set of instructions that are installed on the processor 30 and/or the spectrum estimation module 50. It should be realized that the methods described herein may be applied to any imaging system and the imaging system 10 shown in FIG. 1 is one embodiment of such an exemplary imaging system. Referring to FIG. 2, at 102 an air calibration is performed on the imaging system 10 to generate a set of air calibration data.

In the exemplary embodiment, the air calibration is a physics-based calibration of the imaging system 10 that is performed to acquire the set of air calibration data. The physics based calibration may be initiated by the user by selecting or activating an appropriate icon and/or button on the imaging system 10. Performing a physics-based calibration includes calibrating the imaging system to correct for beam hardening, scatter radiation, off-focal radiation, and/or other inaccuracies that may be produced as a result of rotating the gantry during operation. For example, the polychromatic nature of x-ray sources used in at least some CT imaging systems may induce beam-hardening artifacts in the reconstructed images. In a human body being imaged, there are two main components that lead to distinct beam hardening effects: one arising from soft tissue and the other from bone. Moreover, detection efficiency of the detector elements 24 may change with x-ray spectrum hardened by different materials, resulting in detection system related image artifacts. Accordingly, to acquire the calibration data, in one embodiment, a plurality of air scans of a water phantom (not shown) may be performed. In the exemplary embodiment, at least one air scan is performed with the x-ray source 12 set at a predetermined voltage level (kVp). In various embodiments, a plurality of air scans may be performed with the x-ray source 12 set at different voltage levels. For example, a first air scan may be performed at a first kVp, a second air scan may be performed at a second different kVp, etc. The detection efficiencies of the detector 20 may then be estimated using the projection values acquired from the detector 20 as described below. Thus, an ideal spectral effect may be modeled by simulation of an x-ray beam spectrum and its interaction with materials such as the bowtie filter 22 in the beam path and the water phantom.

At 104, in various embodiments, a gain map is applied to the calibration data acquired at 102. More specifically, in operation, the various detector elements 24 may have a different gain. Accordingly, at 104, the gain for each detector element 24 is estimated. The estimated gain then may be utilized during the image reconstruction process discussed below.

At 106, the dimensions and material of the bowtie filter 22 are determined or acquired. In various embodiments, the dimensions and/or size and the material used to fabricate the bowtie filter 22 are known based on a priori information. Thus, the dimensions and size of the bowtie filter 22 may be stored in the imaging system 10 and then accessed by the method 100 during operation. In various embodiments, the dimensions and material used to fabricate the bowtie filter 22 are stored in the processor 30 and may be accessed by the spectrum estimation module 50 using the methods described herein.

At 108, the air calibration data is utilized by the spectrum estimation module 50 to generate an initial estimate of the x-ray spectrum of the x-ray source 12. More specifically, an expectation maximization (EM) algorithm may be utilized by the spectrum estimation module 50 to estimate the x-ray spectrum of the x-ray source 12. An EM algorithm, in various embodiments, is a statistical algorithm that utilizes an iterative method to simultaneously or concurrently segment the set of air scan data and estimate the x-ray spectrum. More specifically, it is difficult to measure the x-ray spectrum directly at the x-ray source 12. Thus, the transmission data acquired from the detector 20, i.e. the set of air scan data provides an indirect measurement that may be utilized to estimate the x-ray spectrum.

For example, because the thickness and material composition of the bowtie filter 22, and any additional filters, is known, this information may be used to model the x-ray spectrum, in real time, in accordance with:

$$\begin{matrix}T = \frac{I}{{I}_{0}} \\ = {\int }_{{E}_{min}}^{{E}_{max}} s ( E ) D ( E ) {e}^{- {\int }_{t} μ ( E , x ) d l} d E \\ = W ( E ) {e}^{- {\int }_{t} μ ( E , x ) d l} d E\end{matrix} \qquad Equation 1$$

wherein:
T is the transmission data, i.e. the set of air scan data that is the input to Equation 1.
I is the measured intensity of photons detected by the detector 20.
I₀ is the intensity of photons output from the x-ray source 12.
Eₘᵢₙ is minimum energy range of the spectrum, such as for example, 0 kVp.
Eₘₐₓ is maximum energy range of the spectrum, such as for example, 140 kVp.
s(E) is the x-ray source 12 spectrum.
D(E) is a detector response function.
W(E) is the target spectrum function to be estimated.

Moreover, the exponential term

$$- {\int }_{t} μ ( E , x ) d l$$

models the bowtie attenuation. Accordingly, μ is the attenuation caused by the bowtie filter 22 and t is the thickness of the bowtie filter 22.

It should be realized the various parameters used in Equation 1 are exemplary only. For example, and Eₘᵢₙ and Eₘₐₓ may be set to any desired value based upon, for example, the imaging system being calibrated.

In the exemplary embodiment, Equation 1 is linearized to solve for the value W(E) in accordance with:

$$\begin{matrix}{T}_{j} = {\sum }_{i = 1}^{N} {A}_{i , j} {w}_{i} , j = 1 , … M , & Equation 2 \\ {A}_{i , j} = {e}^{- {\int }_{t} {μ}_{j} ( {E}_{i} , x ) d l} & Equation 3\end{matrix}$$

where:
i is the energy range in W(E), e.g. between Eₘᵢₙ and Eₘₐₓ.
j is the number of points of the measurement.
N is the number of samplings of the spectrum.
M is the total number of transmission measurements.
A is the linear system matrix calculated from the linear attenuation coefficients and the thickness of bowtie and the bowtie material.
wᵢ is the spectrum sampling.

Accordingly, Equation 1 is transformed or linearized using Equations 2 and 3 into a linear equation which is defined as:

$${w}_{j}^{k + 1} = \frac{{w}_{j}^{k}}{{\sum }_{j} {A}_{i , j}} {\sum }_{i} \frac{{A}_{i , j} {t}_{i}}{{\sum }_{l} {A}_{i , j} {w}_{l}} \qquad Equation 4$$

In operation, Equation 4 rearranges Equations 2 and 3 to enable the spectrum estimation module 50 to solve for W(E) which is the combined x-ray spectrum. The original spectrum is used as the initial estimate of the iteration.

At 110, the results of Equation 4 are tested using a dual-energy material decomposition algorithm. More specifically, the results of Equation 4 are utilized to reconstruct a material image. In various embodiments, transmission data acquired from a previous scan may be input the spectrum estimation module 50. The spectrum estimation module 50 then utilizes the results of Equation 4 to reconstruct an exemplary material image.

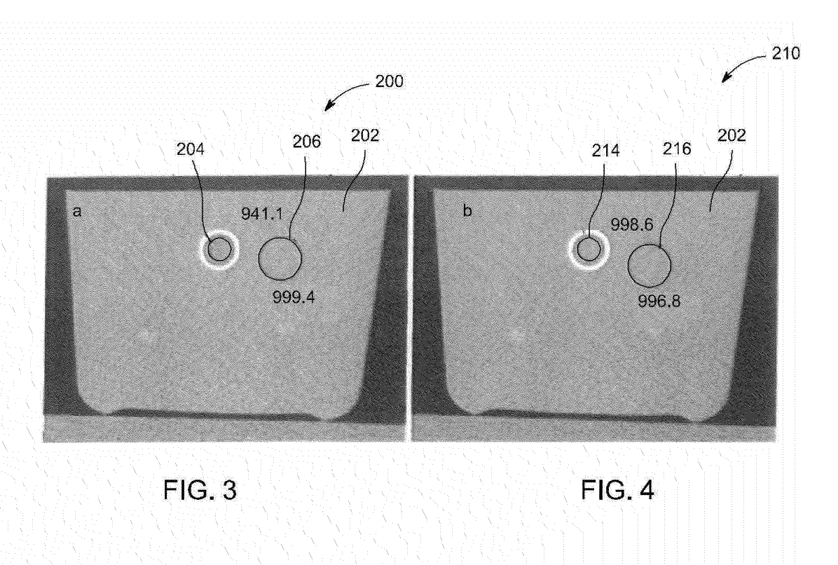

For example, FIG. 3 is an image 200 of an exemplary water image 202 that may be reconstructed at 110. As shown in FIG. 3, the area defined by a circle 204 represents the portion of the image 200 that contains iodine. After material decomposition, only water is shown in the water image 202. As shown in FIG. 3, the number 941.1 represents the water HU within the area defined by a circle 204. Moreover, the number 999.4 represents the pure water HU within the area defined by a circle 206. It should be realized that in the exemplary embodiment, for a perfect imaging system, the HU for pure water is 1000. Accordingly, FIG. 3 illustrates the portion of the image 200 reconstructed using the initial x-ray spectrum information is less than 1000 HU.

Accordingly, at 112, Equation 4 may be automatically performed for a plurality of iterations to improve the x-ray spectrum estimate. As discussed above, the value k in Equation 4 represents the number of iterations. Accordingly, k may be 1, 2, 3 or more iterations. In various embodiments, Equation 4 is performed until the result of Equation 4 converges to some value that is within a predetermined range of 1000 Hu. For example, Equation 4 may be performed until the result of Equation 4 converges to some value that is 995 Hu<1000 Hu<1005 Hu. Thus, the spectrum estimation module 50 may be programmed to iterate Equation 4 until the results of the iteration are within ±5% of 1000 Hu. It should be realized that the value of 5% is exemplary, and that the percentage may be set to any value.

FIG. 4 is an image 210 of the exemplary water phantom 202 reconstructed using a final spectrum estimate, e.g. after the plurality of iterations are completed as described above. As shown in FIG. 4, the area defined by a circle 214 represents the portion of the image 210 that is reconstructed using the final spectrum estimate derived above. Moreover, an area defined by a circle 216 represents a portion reconstructed using an optimal x-ray spectrum estimate. As shown in FIG. 4, the number 998.6 represents the Hounsfield units (Hu) within the area defined by a circle 214. Moreover, the number 996.8 represents the Hu within the area defined by a circle 216. Accordingly, the final spectrum estimate is within 5% of the optimal Hu of 1000.

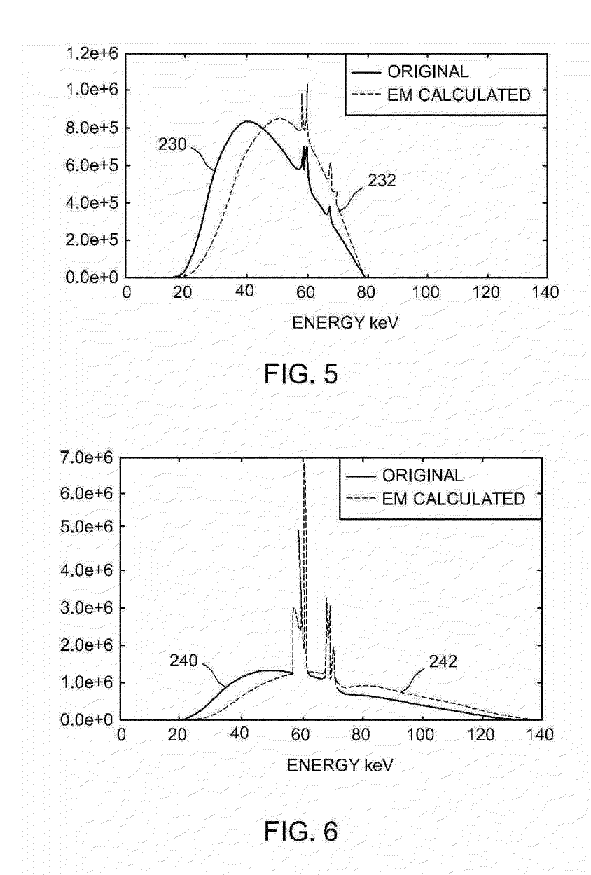

Referring again to FIG. 2, at 114 the results of the spectrum estimate described above may be displayed. For example, FIG. 5 is an exemplary graph wherein the x-axis represents energy at a first kVp level and the y-axis represents HU of photons acquired at the first kVp level. As shown in FIG. 5, the line 230 represents the original x-ray spectrum derived using a conventional technique. The line 232 represents the estimated x-ray spectrum derived using the methods described herein. As shown in FIG. 5, the x-ray spectrum is shifted from the left to the right indicating that the energy level of the final estimated x-ray spectrum is substantially higher than the original x-ray energy spectrum. Accordingly, the final estimated x-ray spectrum is harder than the original x-ray spectrum.

Similarly, FIG. 6 illustrates the results of the spectrum estimate described above wherein the x-axis represents energy at a second kVp level and the y-axis represents number of photons acquired at the second kVp level. As shown in FIG. 6, the line 240 represents an original x-ray spectrum derived using a conventional technique. The line 242 represents the estimated x-ray spectrum derived using the methods described herein. As shown in FIG. 6, the x-ray spectrum, similar to FIG. 5, is shifted from the left to the right indicating that the energy level of the final estimated x-ray spectrum is substantially higher than the original x-ray energy spectrum. Accordingly, the final estimated x-ray spectrum is harder than the original x-ray spectrum.

Referring again to FIG. 2, at 116 the operator may be prompted to accept the results of the spectrum estimation. For example, at least one of FIG. 5 or FIG. 6 may be presented to the operator. The operator may then choose to accept the final spectrum estimation or may optionally choose to instruct the spectrum estimation module 50 to perform additional iterations of Equation 4 to improve the spectrum estimation. Of course, this estimation process can also be automatically performed without any operator's actions. After the spectrum estimation process is completed, a visual or audible indication may be displayed or sounded to inform the operator that the calibration process is completed. The final spectrum estimate may then be utilized to reconstruct an image of an object using transmission data acquired during a medical imaging scan or any other transmission data.

Various embodiments described herein provide a method and apparatus for estimating a spectrum of an x-ray source. The methods may be applied to any transmission data collected from any x-ray source. In operation, the methods described herein facilitate improving the accuracy of the x-ray spectrum estimation. Accordingly, the more accurate estimation may be utilized to reconstruct images having reduced imaging artifacts and more accurate quantitative information. Moreover, in various embodiments, the methods and algorithms described herein may be performed in real-time and require less time than conventional spectrum calibration methods. The methods and algorithms described herein may be utilized with a plurality of different imaging systems. Moreover, the methods and algorithms may be implements before a daily air scan is performed or at any other time or periodicity.

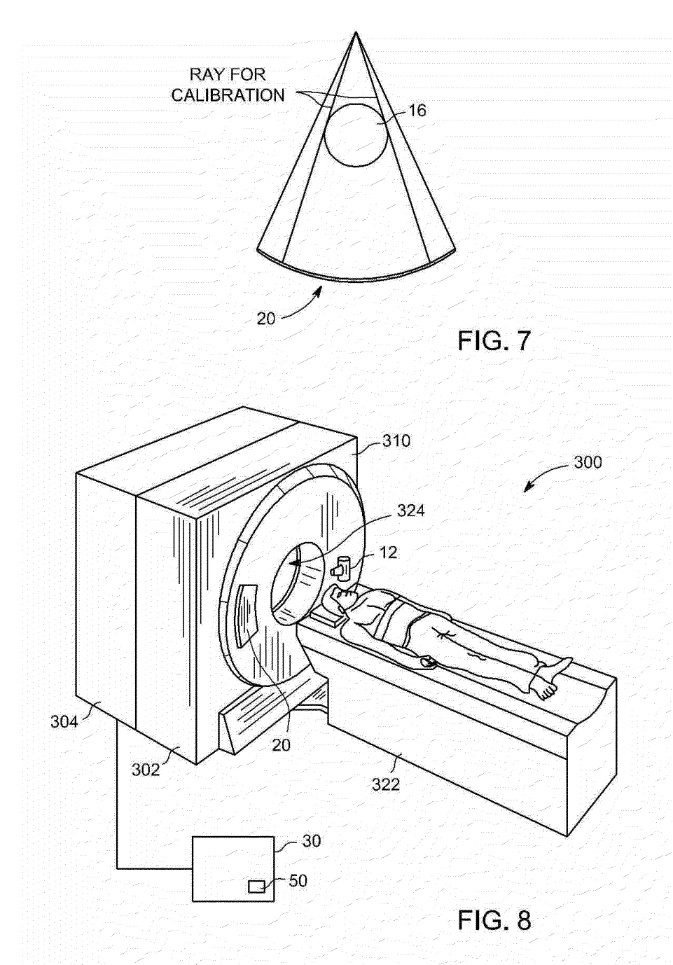

In another embodiment, the air calibration data is not collected separately. Instead, the air calibration data is collected during the patient scanning. Note that in many CT scans of patient, the x-ray 14 beam impinging on some detector channels 24 will not be attenuated by the patients or other objects, as illustrated in FIG. 7. Under such conditions, the channels 24 exposing directly to the x-ray source 12 will collect sufficient data to perform the calibration process illustrated above. The advantage of this approach is the elimination of separate calibration scans, and updated calibration can be performed every time when patient is scanned.

In yet another embodiment, the calibration is performed in an iterative fashion. That is, an image may be reconstructed with an initial calibration. The reconstructed images may then be used to further refine the locations of the channels that pass directly from the x-ray source 12 (post bowtie) to the detector 20 without being attenuated by the patient 16 or other foreign object (note that image space algorithms may be less sensitive to the variation of x-ray flux fluctuation of the x-ray tube and other factors in the determination of the air calibration-ready channels. In addition, the reconstructed object may be used to estimate the impact of scatter in the measured air signals. Using the initial reconstructed images, the algorithm may perform an improved estimation of the flux changes caused by the x-ray spectrum change, and remove other factors. Using the refined calibration vector, a further refined image may be generated.

In yet another embodiment, the imaging system 10 may be embodied as an x-ray radiography system instead of an x-ray CT system. In the radiography system, images are not “reconstructed”. Rather, the measured projection data after calibration steps are displayed as the final image. In dual-energy (DE) x-ray radiography systems, the material-density projections (or material decomposition projections) are generated by weighted subtraction of the high and low-kVp projections (More generally, a set of weights or functions are used to map the high- and low-kVp projections to material-density projections). The weighting factor is determined based on the x-ray spectrum of the high- and low-kVp. If the input x-ray spectrum shifts, sub-optimal material-density projections will result. The method discussed above provide a way for the system to constantly monitor the x-ray spectrum change and provide the best weighting functions (or mapping function) for the material-decomposed projections.

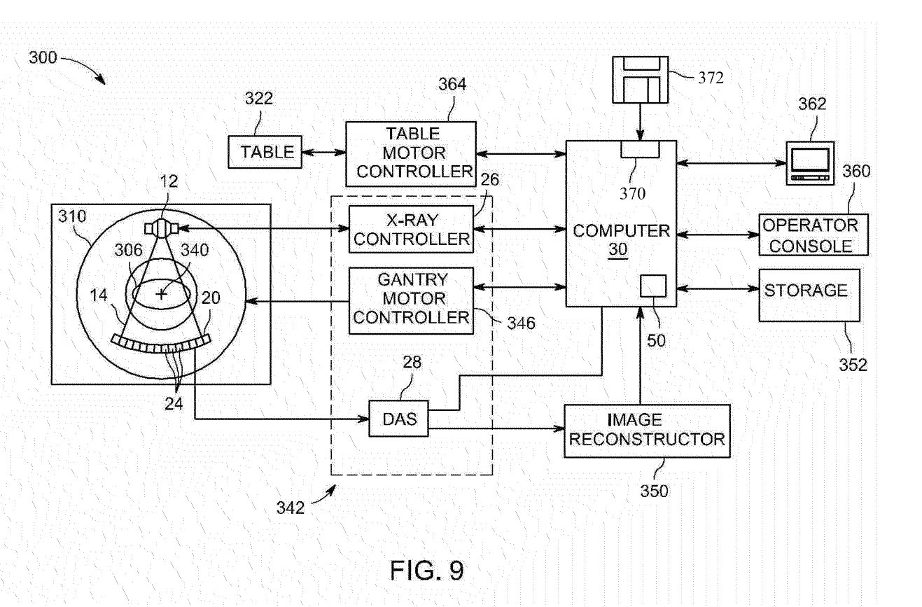

For example, FIG. 8 is a pictorial view of an imaging system 400 that is formed in accordance with various embodiments. FIG. 9 is a block schematic diagram of a portion of the multi-modality imaging system 400 shown in FIG. 8. Although various embodiments are described in the context of an exemplary dual modality imaging system that includes a CT imaging system and a positron emission tomography (PET) imaging system, it should be understood that other imaging systems capable of performing the functions described herein are contemplated as being used.

The multi-modality imaging system 300 is illustrated, and includes a CT imaging system 302 and a PET imaging system 304. The imaging system 300 allows for multiple scans in different modalities to facilitate an increased diagnostic capability over single modality systems. In one embodiment, the exemplary multi-modality imaging system 300 is a CT/PET imaging system 300. Optionally, modalities other than CT and PET are employed with the imaging system 300. For example, the imaging system 300 may be a standalone CT imaging system, a standalone PET imaging system, a magnetic resonance imaging (MRI) system, an ultrasound imaging system, an x-ray imaging system, and/or a single photon emission computed tomography (SPECT) imaging system, interventional C-Arm tomography, CT systems for a dedicated purpose such as extremity or breast scanning, and combinations thereof, among others.

The CT imaging system 302 includes a gantry 310 that has the x-ray source 12 that projects a beam of x-rays 14 toward the detector array 20 on the opposite side of the gantry 310. The detector array 20 includes the plurality of detector elements 24 that are arranged in rows and channels that together sense the projected x-rays that pass through an object, such as the subject 306. The imaging system 300 also includes the computer 30 that receives the projection data from the detector array 20 and processes the projection data to reconstruct an image of the subject 306. In operation, operator supplied commands and parameters are used by the computer 30 to provide control signals and information to reposition a motorized table 322. More specifically, the motorized table 322 is utilized to move the subject 306 into and out of the gantry 310. Particularly, the table 322 moves at least a portion of the subject 306 through a gantry opening 324 that extends through the gantry 310.

The imaging system 300 also includes the spectrum estimation module 50 that is configured to implement various methods described herein. For example, the module 50 may be configured automatically estimate the x-ray spectrum of the x-ray source 12 in real-time and utilize the estimate to reconstruct an image of the subject 306. The module 50 may be implemented as a piece of hardware that is installed in the computer 30. Optionally, the module 50 may be implemented as a set of instructions that are installed on the computer 30. The set of instructions may be stand alone programs, may be incorporated as subroutines in an operating system installed on the computer 30, may be functions in an installed software package on the computer 30, and the like. It should be understood that the various embodiments are not limited to the arrangements and instrumentality shown in the drawings.

As discussed above, the detector 20 includes a plurality of detector elements 24. Each detector element 24 produces an electrical signal, or output, that represents the intensity of an impinging x-ray beam and hence allows estimation of the attenuation of the beam as it passes through the subject 306. During a scan to acquire the x-ray projection data, the gantry 310 and the components mounted thereon rotate about a center of rotation 340. FIG. 9 shows only a single row of detector elements 24 (i.e., a detector row). However, the multislice detector array 20 includes a plurality of parallel detector rows of detector elements 24 such that projection data corresponding to a plurality of slices can be acquired simultaneously during a scan.

Rotation of the gantry 310 and the operation of the x-ray source 12 are governed by a control mechanism 342. The control mechanism 342 includes the x-ray controller 26 that provides power and timing signals to the x-ray source 12 and a gantry motor controller 346 that controls the rotational speed and position of the gantry 310. The data acquisition system (DAS) 28 in the control mechanism 342 samples analog data from detector elements 24 and converts the data to digital signals for subsequent processing. For example, the subsequent processing may include utilizing the module 50 to implement the various methods described herein. An image reconstructor 350 receives the sampled and digitized x-ray data from the DAS 28 and performs high-speed image reconstruction. The reconstructed images are input to the computer 30 that stores the image in a storage device 352. Optionally, the computer 30 may receive the sampled and digitized x-ray data from the DAS 28 and perform various methods described herein using the module 50. The computer 30 also receives commands and scanning parameters from an operator via a console 360 that has a keyboard. An associated visual display unit 362 allows the operator to observe the reconstructed image and other data from computer.

The operator supplied commands and parameters are used by the computer 30 to provide control signals and information to the DAS 28, the x-ray controller 26 and the gantry motor controller 346. In addition, the computer 30 operates a table motor controller 364 that controls the motorized table 322 to position the subject 306 in the gantry 310. Particularly, the table 322 moves at least a portion of the subject 306 through the gantry opening 324 as shown in FIG. 8.

Referring again to FIG. 9, in one embodiment, the computer 30 includes a device 370, for example, a floppy disk drive, CD-ROM drive, DVD drive, magnetic optical disk (MOD) device, or any other digital device including a network connecting device such as an Ethernet device for reading instructions and/or data from a non-transitory computer-readable medium 372, such as a floppy disk, a CD-ROM, a DVD or an other digital source such as a network or the Internet, as well as yet to be developed digital means. In another embodiment, the computer 30 executes instructions stored in firmware (not shown). The computer 30 is programmed to perform functions described herein, and as used herein, the term computer is not limited to just those integrated circuits referred to in the art as computers, but broadly refers to computers, processors, microcontrollers, microcomputers, programmable logic controllers, application specific integrated circuits, and other programmable circuits, and these terms are used interchangeably herein.

In the exemplary embodiment, the x-ray source 12 and the detector array 20 are rotated with the gantry 310 within the imaging plane and around the subject 306 to be imaged such that the angle at which an x-ray beam 374 intersects the subject 306 constantly changes. A group of x-ray attenuation measurements, i.e., projection data, from the detector array 20 at one gantry angle is referred to as a “view”. A “scan” of the subject 306 comprises a set of views made at different gantry angles, or view angles, during one revolution of the x-ray source 12 and the detector 20. In a CT scan, the projection data is processed to reconstruct an image that corresponds to a two dimensional slice taken through the subject 306.

Exemplary embodiments of a multi-modality imaging system are described above in detail. The multi-modality imaging system components illustrated are not limited to the specific embodiments described herein, but rather, components of each multi-modality imaging system may be utilized independently and separately from other components described herein. For example, the multi-modality imaging system components described above may also be used in combination with other imaging systems.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional elements not having that property.

Also as used herein, the phrase “reconstructing an image” is not intended to exclude embodiments of the present invention in which data representing an image is generated, but a viewable image is not. Therefore, as used herein the term “image” broadly refers to both viewable images and data representing a viewable image. However, many embodiments generate, or are configured to generate, at least one viewable image.

As used herein, the terms “software” and “firmware” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions and types of materials described herein are intended to define the parameters of the invention, they are by no means limiting and are exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose the various embodiments of the invention, including the best mode, and also to enable any person skilled in the art to practice the various embodiments of the invention, including making and using any devices or systems and performing any incorporated methods. The patentable scope of the various embodiments of the invention is defined by the claims, and may include other examples that occur to those skilled in the art. Such other examples are intended to be within the scope of the claims if the examples have structural elements that do not differ from the literal language of the claims, or if the examples include equivalent structural elements with insubstantial differences from the literal languages of the claims.

What is claimed is:

1. A method for reconstructing an image of an object, said method comprising:
performing an air calibration on an imaging system to generate set of air calibration data;
estimating an x-ray spectrum using the air calibration data; and
reconstructing an image of an object using the estimated x-ray spectrum.

2. The method of claim 1, wherein the air calibration is performed concurrently with a diagnostic scan of a patient.

3. The method of claim 1, further comprising iteratively estimating the x-ray spectrum, wherein iteratively estimating the x-ray spectrum includes reconstructing at least one image using the estimated x-ray spectrum, and using the at least one image to determine the locations of at least one x-ray beam that passes directly from an x-ray source to a detector

4. The method of claim 1, wherein in the imaging system comprises an x-ray radiography system.

5. The method of claim 1, further comprising automatically estimating the x-ray spectrum using the air calibration data.

6. The method of claim 1, further comprising iteratively updating the estimated x-ray spectrum.

7. The method of claim 1, wherein estimating the x-ray spectrum comprises;
receiving an input of a bowtie filter material and a bowtie filter thickness; and
estimating the x-ray spectrum using the bowtie filter material and thickness.

8. The method of claim 1, wherein estimating the x-ray spectrum comprises utilizing an expectation maximization algorithm to estimate the x-ray spectrum.

9. The method of claim 8, further comprising iteratively performing the expectation maximization algorithm for a predetermined number of iterations.

10. The method of claim 8, further comprising iteratively performing the expectation maximization algorithm until the estimated x-ray spectrum exceeds a predetermined Hounsfield unit threshold.

11. The method of claim 1, further comprising performing an expectation maximization based on dual-energy two-material decomposition results.

12. An imaging system comprising:
an imaging scanner; and
a processor coupled to the imaging scanner, the processor configured to:
perform an air calibration on an imaging system to generate set of air calibration data;
estimate an x-ray spectrum using the air calibration data; and
reconstruct an image of an object using the estimated x-ray spectrum.

13. The imaging system of claim 12, wherein the processor is further configured to automatically estimate the x-ray spectrum using the air calibration data.

14. The imaging system of claim 12, wherein the processor is further configured to iteratively revise the estimated x-ray spectrum.

15. The imaging system of claim 12, wherein the processor is further configured to:
receive an input of a bowtie filter material and a bowtie filter thickness; and
estimate the x-ray spectrum using the bowtie filter material and thickness.

16. The imaging system of claim 12, wherein the processor is further configured to utilize an expectation maximization algorithm to estimate the x-ray spectrum.

17. The imaging system of claim 12, wherein the processor is further configured to iteratively perform the expectation maximization algorithm for a predetermined number of iterations.

18. The imaging system of claim 12, wherein the processor is further configured to iteratively performing the expectation maximization algorithm until the estimated x-ray spectrum exceeds a predetermined Hounsfield unit threshold.

19. The imaging system of claim 12, wherein the processor is further configured to perform an expectation maximization based on dual-energy two-material decomposition results.

20. A non-transitory computer readable medium being programmed to instruct a computer to:
perform an air calibration on an imaging system to generate set of air calibration data;
estimate an x-ray spectrum using the air calibration data; and
reconstruct an image of an object using the estimated x-ray spectrum.

21. The non-transitory computer readable medium of claim 20, further programmed to instruct the computer to iteratively revise the estimated x-ray spectrum.

22. The non-transitory computer readable medium of claim 20, further programmed to instruct the computer to:
receive an input of a bowtie filter material and a bowtie filter thickness; and
estimate the x-ray spectrum using the bowtie filter material and thickness.

23. The non-transitory computer readable medium of claim 20, further programmed to instruct the computer to utilize an expectation maximization algorithm to estimate the x-ray spectrum.
